(19) United States
(12) Patent Application Publication
(10) Pub. No.: US 2003/0156113 A1
(43) Pub. Date: Aug. 21, 2003

(54) Methods of combining animation and live video using looped animation and related systems

(76) Inventors: Darryl Freedman, Chapel Hill, NC (US); Mary A. Freedman, Chapel Hill, NC (US); Jeffrey B. Freedman, Laurel, MD (US)

Correspondence Address: MYERS BIGEL SIBLEY & SAJOVEC, PO BOX 37428, RALEIGH, NC, 27627, US

(21) Appl. No.: 10/078,626

(22) Filed: Feb. 19, 2002

(51) Int. Cl. G06T 15/70

(52) U.S. Cl. 345/473

(57) ABSTRACT

A method of combining animation and live video can include generating an animation sequence and generating a live video signal. The animation sequence can be looped to provide a looped animation sequence, and the looped animation sequence and the live video signal can be combined. The combined looped animation sequence and live video signal can be displayed such that the animation sequence appears in front of the live video. Related systems are also discussed.

### BACKGROUND OF THE INVENTION

The present invention relates to the field of video production and more particularly to combining live video and animation.

Combinations of video and animation have been used to provide special effects. The techniques and equipment used to provide these combinations, however, may be complicated and/or expensive. Accordingly, there continues to exist a need in the art for methods and systems of combining video and animation that can be relatively inexpensive and/or easy to implement.

### SUMMARY OF THE INVENTION

According to embodiments of the present invention, an animation sequence and live video can be generated, and the animation sequence can be looped. The looped animation sequence and the live video signal can be combined, and the combined looped animation sequence and live video signal can be displayed such that the animation sequence appears in front of the live video. By looping through iterations of an animation sequence and combining the looped animation sequence with live video, an actor can repeatedly perform/rehearse with the animation sequence while viewing the combination in real time.

According to additional embodiments of the present invention, an animation sequence can be generated comprising an animated character on a background, and a live video signal can be generated. The animation sequence and the live video signal can be combined by superimposing the animated character on the video signal such that the background of the animation sequence is transparent with respect to the video signal, and the combined animation sequence and live video signal can be displayed. By providing a background of an animation sequence for which live video can be substituted, animated characters and video can be combined using relatively inexpensive equipment. The background, for example, can be defined by a uniform color, luminosity, and/or intensity.

### BRIEF DESCRIPTION OF THE DRAWINGS

FIG. 1 is a block diagram illustrating systems and methods of combining animation and live video according to embodiments of the present invention.

FIG. 2 is a schematic diagram illustrating systems and methods of combining animation and live video according to additional embodiments of the present invention.

FIG. 3 is a flow chart illustrating operations of combining animation and live video according to embodiments of the present invention.

FIGS. 4A-C respectively illustrate frames of an animation sequence, live video, and a combination according to embodiments of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

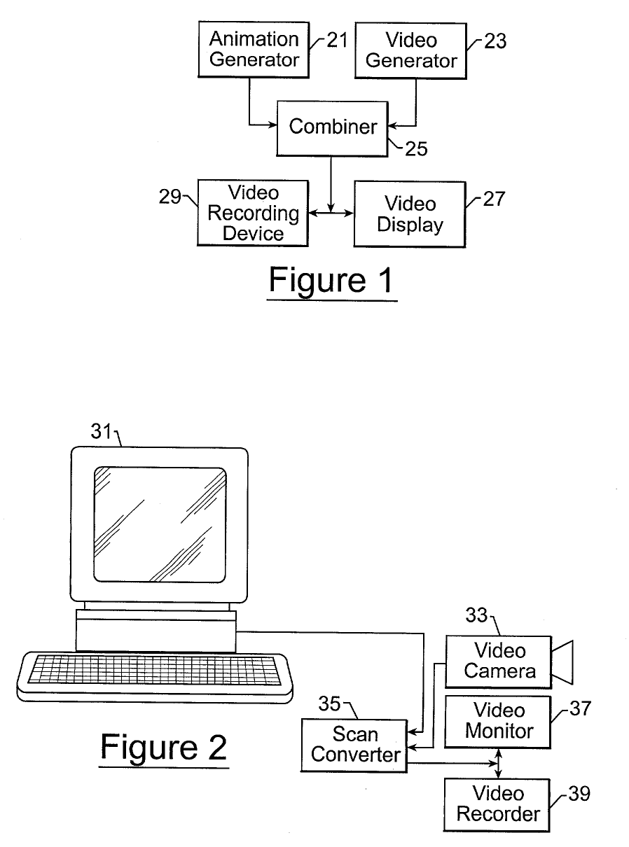

As illustrated in FIG. 1, methods and systems can be provided for combining animation and live video according to embodiments of the present invention. As shown, a looped animation sequence can be generated by an animation generator 21, and a live video signal can be generated by a video generator 23. The looped animation sequence and the live video signal can be provided to a combiner 25, and the combined output can be provided to a video display 27 and/or a video recording device 29. While a parallel coupling from the combiner 26 to the video recording device 29 and the video display 27 is illustrated, it will be understood that a serial coupling may be provided. The output of the combiner 25, for example, may be provided directly to the video recording device 29, and provided from the video recording device to the video display 27. Alternatively, the output of the combiner 25 may be provided directly to the video display 27, and provided from the video display 27 to the video recording device 29. In addition, the video display 27 and the video recording device 29 may be implemented as a single unit. Moreover, additional blocks of FIG. 1 can be implemented in a combined unit(s).

The animation generator 21 can be used to generate an animated sequence to be combined with live video. More particularly, the animated sequence can include an animated character and/or object (or characters and/or objects) generated on a background such that when combined with the -live video, the animated character or object appears in the foreground of the combined output generated by the combiner 25, and the live video appears in the background of the combined output generated by the combiner 25. For example, an animated character (animal, person, object, etc.) can be generated by the animation generator 21 on a background of a predetermined color such that the combiner superimposes the live video on the background and the animated character appears in front of the live video. As used herein after, the term character is defined to include an animated character, person, animal, and/or other animated object. While a predetermined color (such as blue) can be used for the background, other characteristics can be used alone or in combination to define the background. For example, a predetermined color, luminosity, and/or intensity can be used to define the background.

By way of example, the background color can be blue and the combiner 25 can be set to recognize blue as the background. “Blue screen” technology is known, for example, in television news reporting where a weathermen (live actor) stands in front of a blue background, and a weather map is substituted for the blue background so that the weather map appears behind the weather man. Blue Screen technology is discussed for example by Marshall Brian in “How Blue Screen Special Effects Work” (www.howstuffworks.com/blue-screen.htm, printed Nov. 30, 2001), and by Bob Kertesz in “The Blue Screen Page” (www.seanet.com/Users/bradford/bluscrn.html, printed Nov. 29, 2001). The disclosures of both of these references are hereby incorporated herein in their entirety by reference. In contrast, embodiments of the present invention use animation on a blue background with live video being substituted for the background of the animation. In other words, the video generator 23 can be used to generate live video of an actor, and the animation generator 21 can be used to generate an animated sequence of an animated character that is inserted in front of the live video.

The combined output can be provided to the video display 27 so that the actor can view his/her interaction with the animated character in real time. Moreover, the animation generator 21 can repeatedly loop iterations of the animated sequence so that the animated sequence is repeated without requiring intervention during the looping. The actor-can thus repeatedly perform/rehearse a storyline with an animated character in front of the video display 27 while simultaneously recording on the video recording device 29. By watching him/herself and the animated character on the video display 27 in real time during repeated performances/rehearsals, the actor can quickly develop realistic interactions with the animated character. Once the actor has performed through a number of iterations of the looped animation sequence, all of which have been recorded by the video recording device 29, the best performance can be selected and saved or portions from various sequences can be edited and/or combined.

In addition, the animation generator 21 can provide a predetermined delay between each loop of the animation sequence. This delay can be used by the actor to reposition and prepare for the next loop of the animation sequence. The duration of this delay can be defined by the actor and can be changed according to individual preferences. During the delay, the animation generator may freeze the last frame of the animation sequence for display with live video, the animation generator may freeze the first frame of the animation sequence for display with the live video, or the animation generator may freeze an intermediate frame of the information sequence for display with the live video. Any frame that would assist the actor in preparation for the next iteration of the animation sequence can be generated by the animation generator 21 during the delay. Alternatively, the animation generator 21 can generate a blank output (background only with no animated character) during the predetermined delay so that only live video is provided to the video display 27 during the predetermined delay.

By looping the animation sequence and providing delay between iterations, a video recording can be quickly produced with realistic interaction between one or more live actors and one or more animated characters in an animated sequence. Moreover, methods and systems according to embodiments of the present invention can be implemented at relatively low cost, for example, using a personal, laptop, or notebook computer to generate the animated sequence; using a video camera to generate live video; using a video cassette recorder to record; and using a television or computer monitor as a display. Methods and systems according to embodiments of the present invention may thus be especially useful in educational, home, and other applications where cost is a primary concern.

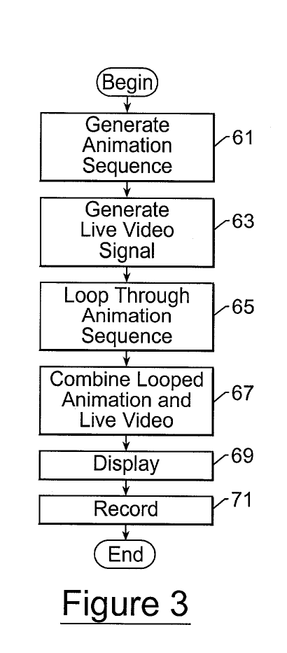

Additional methods and systems according to embodiments of the present invention are illustrated in FIG. 2. As shown, a looped animation sequence can be generated by a computer 31 such as a personal, laptop, or notebook computer; and a live video signal can be generated by a video camera 33. The looped animation sequence and the live video signal can be provided to a scan converter 35, and the output of the scan converter 35 can be provided to a video monitor 37 and a video recorder 39. While a parallel coupling from the scan converter 35 to the video recorder 39 and the video monitor 37 is illustrated, it will be understood that a serial coupling may be provided. The output of the scan converter 35, for example, may be provided directly to the video recorder 39, and provided from the video recorder to the video display 37. Alternatively, the output of the scan converter 35 may be provided directly to the video monitor 37, and provided from the video monitor 37 to the video recorder 39. In addition, the video monitor 37 and the video recorder 39 may be implemented as a single unit.

An animated sequence can thus be generated by the computer 31 with an animated character on a background, for example, of a uniform color, luminosity, and/or intensity. More particularly, the animated sequence can be provided on a computer readable medium such as an optical or magnetic disk or a magnetic tape or a semiconductor memory; the animated sequence can be generated by a user of the computer; or the animated sequence can be generated by modifying an existing sequence (such as a canned sequence provided on an optical or magnetic disk, a magnetic tape or a semiconductor memory). The video camera generates live video, and the live video and the animated sequence are combined by the scan converter. In particular, the scan converter combines the animated sequence and the live video such that an animated character of the sequence appears in the foreground and the live video appears in the background.

For example, a uniform color of the background of the animated sequence can be defined such that the scan converter will substitute live video from the video camera for portions of the animated sequence having the uniform color. The uniform color can be chosen so that no portion of the animated character comprises the uniform color. In other words, any portion of the animated sequence comprising the uniform color will be essentially transparent so that live video is substituted therefore. Typically, the uniform color can be blue which can be recognized as a background by known scan converters. Alternatively, a predetermined luminosity and/or intensity can be used instead of or in addition to color to define the background.

The combination of the animation sequence and live video is provided on the video monitor 37, and one or more actors can thus view interactions with one or more animated characters in real time. In other words, the video camera can be trained on a performance area, and the video monitor can be viewed by the actor(s) in the performance area. When the animated sequence is played and the actor(s) perform in front of the video camera, the resulting live video is combined with the animated sequence and the actor(s) can view the combined image on the video monitor 37 as the performance is occurring.

Because the animated sequence can be looped, the actor(s) can quickly perform/rehearse a number of iterations to achieve realistic interactions with an animated character(s) of the sequence. Moreover, a delay of predetermined length provided at the end of each loop of the video sequence allows the actor(s) to position and prepare for the next iteration. Because each of the iterations is recorded on the video recorder 39, the best of the repeated performances can be selected for subsequent use.

An animation sequence can be generated on the computer 31 using existing animation software applications. Animation software is discussed, for example, in U.S. Pat. No. 5,945,999 entitled “Animation Methods, Systems, And Program Products For Combining Two And Three Dimensional Objects” to Freedman et al. The '999 patent is assigned to the assignee of the present invention and both the '999 patent and the present invention share common inventors. The disclosure of the '999 patent is hereby incorporated herein in its entirety by reference.

According to embodiments of the present invention, the animation sequence can be generated, for example, in any digital video format such as in the “AVI” format or the “MPEG” format, and the animation sequence can be played using a commercially available player such as Microsoft Player TM. Moreover, the looping can be provided by the player, and a delay can be provided between loops by rendering the animated sequence for a longer period of time than the sequence runs.

The video recorder 39 can record the output of the scan converter 35, for example, in a magnetic medium such as a magnetic tape or disk, in an optical medium such as a compact disk, in a semiconductor memory, and/or in any other medium suitable for the storage of video. The video monitor 37 can comprise a television, a computer monitor, a flat panel display, a cathode ray tube, a liquid crystal display, a plasma display, and/or any other video display. The video camera 33 can be a camcorder. In addition, a recording portion of a camcorder may be used for the video recorder 39.

The scan converter 35 can accommodate a variety of standards by providing multiple inputs and outputs. A choice of serial and coaxial outputs can be provided for output to the video recorder 39, and a choice of serial and coaxial inputs can be provided for input from the video camera 33. In addition, a VGA input can be provided for input from the computer 31, and a VGA output can be provided for a computer monitor. In addition, the scan converter 35 can operate in a National Television Systems Committee (NTSC) mode to accommodate operation with equipment produced in the United States or in a Phase Alternate Line (PAL) mode to accommodate operation with equipment produced in Europe.

In addition, different backgrounds for the animation sequence can be accommodated. More particularly, the animation sequence can be generated such that the background is one of a plurality of predetermined colors, and the scan converter can be set to recognize the color being used for the background. For example, the scan converter can be set to accommodate a blue background or a black background on the animation sequence such that the scan converter recognizes the selected color as being background of the animation sequence and such that the live video is substituted for the recognized background of the animation sequence. Alternatively or in addition, the background can be defined by one or more other characteristics such as luminosity and/or intensity.

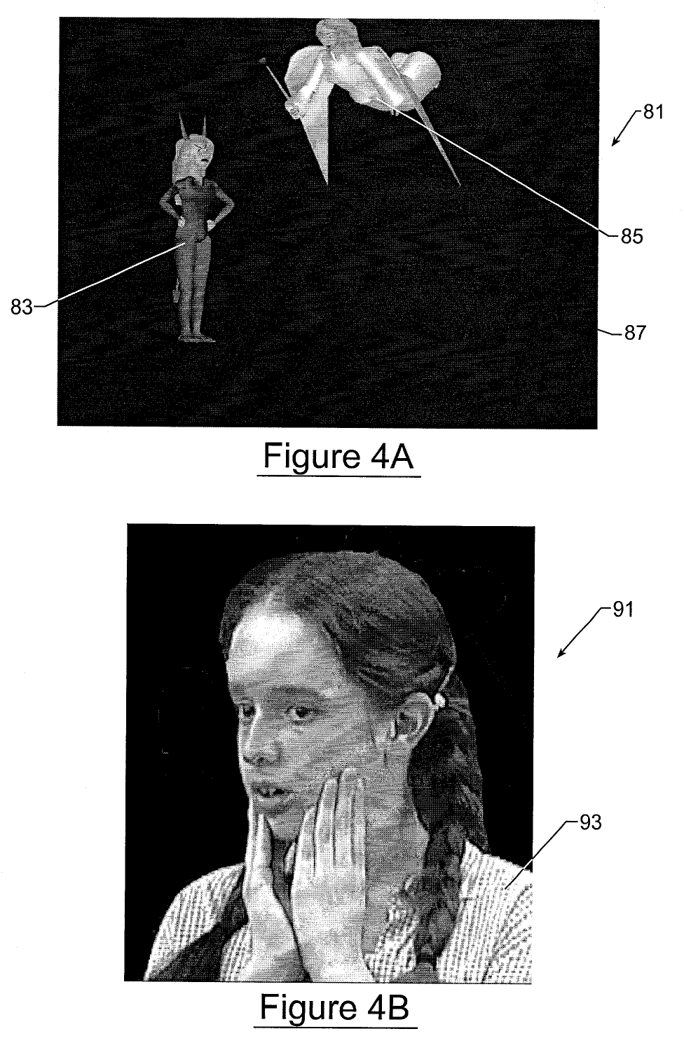

Operations according to embodiments of the present invention are illustrated in the flow chart of FIG. 3. As shown, an animation sequence can be generated at block 61, and a live video signal can be generated at block 63. The animation sequence can be looped at block 65, and the looped animation sequence can be combined with the live video sequence at block 67. The combined looped animation sequence and live video signal can be displayed at block 69 and recorded at block 71.

Moreover, the operations of FIG. 3 can be performed at the same time such that live video of an actor is combined with a looped animation sequence with the combination being displayed and recorded in real time.

Accordingly, the actor can view the combined animation and live video while performing. In other words, the actor can view his/her interaction with character(s) and/or object(s) of the animated sequence while acting out the sequence.

By looping through the animation sequence, the actor can perform the sequence a number of times, with each performance being recorded so that the best performance can be saved for later use. In addition, looping through the animation sequence can include providing a predetermined delay before starting through a next iteration of the looped animation sequence. The delay can provide time for the actor to prepare and/or reposition for the next iteration of the animation sequence. Moreover, a last, first, or intermediate frame of the animation sequence can be combined with the live video during the delay and the combination displayed, thereby allowing the actor to prepare and/or reposition relative to the selected frame of the animation sequence.

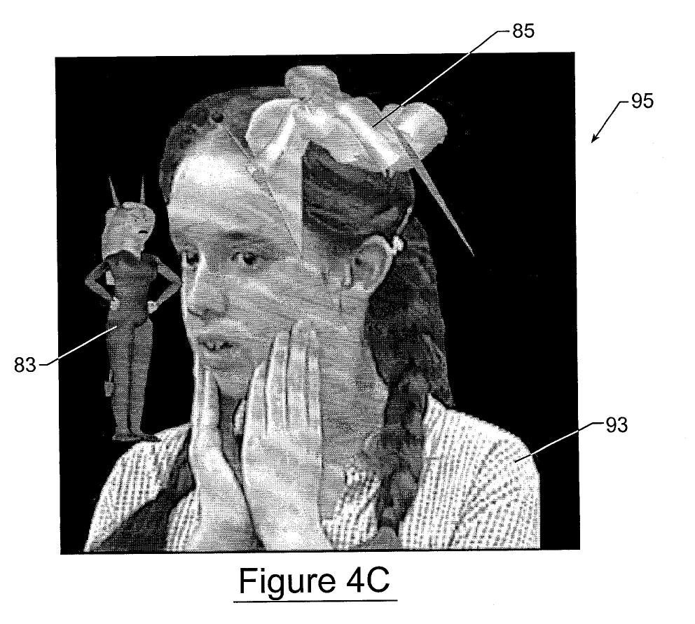

Examples of animation, video, and combinations thereof according to embodiments of the present invention are illustrated in FIGS. 4A-C. FIG. 4A illustrates an example of a frame 81 of an animation sequence that can be generated. As shown in FIG. 4A, the animation sequence can include one or more animated character(s) or object(s) such as the devil 83 and the angel 85 on a background 87 of a uniform color (such as blue). The animated characters can move, talk, and/or otherwise perform over the course of the animated sequence. FIG. 4B illustrated an example of a frame 91 of live video that is combined with the animation sequence. As shown in FIG. 4B, an actor 93 can perform in the live video that is combined with the animation sequence.

FIG. 4C illustrates the combination of the animated characters or objects 83 and 85 of the animated sequence of FIG. 4A with the live video of FIG. 4B. As discussed above, the animated characters or objects are superimposed on the live video so that the animated characters appear to be in front of the live video. Stated in other words, the live video is substituted for the background 87 of the animation sequence.

By displaying the combination of the animated character(s) and/or object(s) and the live video within view of the actor during a performance/rehearsal, the actor can view the interaction in real time. By looping the animation sequence, the actor can repeat the performance a number of times to quickly develop realistic interactions with the animated characters or objects. By providing a delay between each iteration of the looped sequence, the actor can reposition and/or prepare for the next iteration. By recording each iteration, the best performance can be selected and saved after performing/rehearsing through a number of iterations.

The present invention may be embodied as methods or systems. In addition, the invention may take the form of an entirely hardware embodiment, an entirely software embodiment, or an embodiment combining both hardware and software aspects. The present invention has been described in part with respect to the block diagrams of FIGS. 1 and 2 and the flow chart of FIG. 3. It will be understood that blocks of the illustrations, and combinations of blocks, can be implemented by computer program instructions. These program instructions, which may represent steps, may be provided to a processor to produce a machine.

Accordingly, blocks of the block diagrams support combinations of means for performing the specified functions in combinations of steps for performing the specified functions. It will be understood that blocks of the illustrations, and combinations of blocks, can be implemented by special purpose hardware-based systems which perform the specified functions or steps, or combinations of special purpose hardware and computer instructions.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of combining animation and live video, the method comprising:
generating an animation sequence;
generating a live video signal;
looping through iterations of the animation sequence to provide a looped animation sequence;
combining the looped animation sequence and the live video signal; and
displaying the combined looped animation sequence and live video signal such that the animation sequence appears in front of the live video.

2. A method according to claim 1 further comprising:
recording the combined looped animation sequence and live video signal.

3. A method according to claim 1 wherein looping through the animation sequence comprises providing a predetermined delay at the end of each iteration of the animation sequence such that the animation sequence does not loop to the next iteration until the predetermined delay has elapsed after the end of the animation sequence.

4. A method according to claim 3 wherein the last frame of the animation sequence is frozen during the predetermined delay.

5. A method according to claim 3 wherein the animation sequence is blank during the predetermined delay.

6. A method according to claim 1 wherein generating the animation sequence comprises generating an animated object on a background and wherein combining the looped animation sequence and the live video signal comprises superimposing the animated object on the video signal such that the background is transparent with respect to the video signal.

7. A method according to claim 6 wherein the background comprises a uniform color.

8. A method according to claim 7 wherein the uniform color comprises blue.

9. A method according to claim 6 wherein the background comprises a uniform luminosity and/or intensity.

10. A method according to claim 1 wherein the combined looped animation sequence and live video signal are displayed in real time.

11. A method of combining animation and live video, the method comprising:
generating an animation sequence comprising an animated object on a background;
generating a live video signal;
combining the animation sequence and the live video signal by superimposing the animated object on the video signal such that the background of the animation sequence is transparent with respect to the video signal; and
displaying the combined animation sequence and live video signal.

12. A method according to claim 11 further comprising:
looping through iterations of the animation sequence to provide a looped animation sequence;
wherein combining the animation sequence and the live video signal comprises combining the looped animation sequence and the live video signal.

13. A method according to claim 12 wherein the step of looping through the animation sequence comprises providing a predetermined delay at the end of the animation sequence such that the animation sequence does not loop to the next iteration until the predetermined delay has elapsed after the end of the animation sequence.

14. A method according to claim 13 wherein the last frame of the animation sequence is frozen during the predetermined delay.

15. A method according to claim 13 wherein the animation sequence is blank during the predetermined delay.

16. A method according to claim 11 further comprising:
recording the combined animation sequence and live video signal.

17. A method according to claim 11 wherein the background comprises a uniform color.

18. A method according to claim 17 wherein the uniform color comprises blue.

19. A method according to claim 11 wherein the background comprises a uniform luminosity and/or intensity.

20. A method according to claim 11 wherein the combined animation sequence and live video signal is displayed in real time.

21. A system for combining animation and live video, the system comprising:
means for generating an animation sequence comprising an animated object on a background;
means for generating a live video signal;
means for combining the animation sequence and the live video signal by superimposing the animated object on the video signal such that the background of the animation sequence is transparent with respect to the video signal; and
means for displaying the combined animation sequence and live video signal.

22. A system according to claim 21 further comprising:
means for looping through iterations of the animation sequence to provide a looped animation sequence;
wherein the means for combining the animation sequence and the live video signal comprises means for combining the looped animation sequence and the live video signal.

23. A system according to claim 22 wherein the means for looping through the animation sequence comprises means for providing a predetermined delay at the end of iterations of the animation sequence such that the animation sequence does not loop to the next iteration until the predetermined delay has elapsed after the end of the animation sequence.

24. A system according to claim 23 wherein the last frame of the animation sequence is frozen during the predetermined delay.

25. A system according to claim 23 wherein the animation sequence is blank during the predetermined delay.

26. A system according to claim 21 further comprising:
means for recording the combined animation sequence and live video signal.

27. A system according to claim 21 wherein the background comprises a uniform color.

28. A system according to claim 27 wherein the uniform color comprises blue.

29. A system according to claim 21 wherein the background comprises a uniform luminosity and/or intensity.

30. A system according to claim 21 wherein the combined animation sequence and live video signal is displayed in real time.

31. A system for combining animation and live video, the system comprising:
means for generating an animation sequence;
means for generating a live video signal;
means for looping through iterations of the animation sequence to provide a looped animation sequence;
means for combining the looped animation sequence and the live video signal; and
means for displaying the combined looped animation sequence and live video signal such that the animation sequence appears in front of the live video.

32. A system according to claim 31 further comprising:
means for recording the combined looped animation sequence and live video signal.

33. A system according to claim 31 wherein the means for looping through the animation sequence comprises means for providing a predetermined delay at the end of each iteration of the animation sequence such that the animation sequence does not loop to the next iteration until the predetermined delay has elapsed after the end of the animation sequence.

34. A system according to claim 33 wherein the last frame of the animation sequence is frozen during the predetermined delay.

35. A system according to claim 33 wherein the animation sequence is blank during the predetermined delay.

36. A system according to claim 31 wherein the means for generating the animation sequence comprises means for generating an animated object on a background and wherein the means for combining the looped animation sequence and the live video signal comprises means for superimposing the animated object on the video signal such that the background is transparent with respect to the video signal.

37. A system according to claim 36 wherein the background comprises a uniform color.

38. A system according to claim 37 wherein the uniform color comprises blue.

39. A system according to claim 36 wherein the background comprises a uniform luminosity and/or intensity.

40. A system according to claim 31 wherein the combined looped animation sequence and live video signal are displayed in real time.

41. A system of combining animation and live video, the system comprising:
an animation sequence generator that loops through iterations of the animation sequence to provide a looped animation sequence;
a live video signal generator;
a combiner that combines the looped animation sequence and the live video signal; and
a display that displays the combined looped animation sequence and live video signal such that the animation sequence appears in front of the live video.

42. A system according to claim 41 further comprising:
a recorder that records the combined looped animation sequence and live video signal.

43. A system according to claim 41 wherein the animation sequence generator provides a predetermined delay at the end of the animation sequence such that the animation sequence does not loop to the next iteration until the predetermined delay has elapsed after the end of the animation sequence.

44. A system according to claim 43 wherein the last frame of the animation sequence is frozen during the predetermined delay.

45. A system according to claim 43 wherein the animation sequence is blank during the predetermined delay.

46. A system according to claim 41 wherein the animation sequence generator generates an animated object on a background and wherein the combiner superimposes the animated object on the video signal such that the background is transparent with respect to the video signal.

47. A system according to claim 46 wherein the background comprises a uniform color.

48. A system according to claim 47 wherein the uniform color comprises blue.

49. A system according to claim 46 wherein the background comprises a uniform luminosity and/or intensity.

50. A system according to claim 41 wherein the combined looped animation sequence and live video signal are displayed in real time.

51. A system of combining animation and live video, the system comprising:
an animation sequence generator that generates an animation sequence comprising an animated object on a background;
a live video signal generator;
a combiner that combines the animation sequence and the live video signal by superimposing the animated object on the video signal such that the background of the animation sequence is transparent with respect to the video signal; and
a display that displays the combined animation sequence and live video signal.

52. A system according to claim 51 wherein the animation sequence generator loops through iterations of the animation sequence to provide a looped animation sequence, and wherein the combiner combines the looped animation sequence and the live video signal.

53. A system according to claim 52 wherein the animation sequence generator provides a predetermined delay at the end of the animation sequence such that the animation sequence does not loop to the next iteration until the predetermined delay has elapsed after the end of the animation sequence.

54. A system according to claim 53 wherein the last frame of the animation sequence is frozen during the predetermined delay.

55. A system according to claim 53 wherein the animation sequence is blank during the predetermined delay.

56. A system according to claim 51 further comprising:
a recorder that records the combined animation sequence and live video signal.

57. A system according to claim 51 wherein the background comprises a uniform color.

58. A system according to claim 57 wherein the uniform color comprises blue.

59. A system according to claim 51 wherein the background comprises a uniform luminosity and/or intensity.

60. A system according to claim 51 wherein the combined animation sequence and live video signal is displayed in real time.

61. A method of combining animation and live video, the method comprising:
generating an animation sequence on a computer; and
placing the animation sequence on a background such that the animation sequence can be combined with live video with the live video being substituted for the background.

62. A method according to claim 61 wherein the background is of a uniform color and wherein the animation sequence comprises an animated character on the background such that no portion of the animated character comprises the uniform color.

63. A method according to claim 61 wherein the background is of a uniform luminosity and/or intensity and wherein the animation sequence comprises an animated character on the background such that no portion of the animated character comprises the uniform luminosity and/or intensity.

64. A method according to claim 61 wherein generating the animation sequence comprises looping through iterations of the animation sequence.

65. A method according to claim 63 wherein looping through iterations of the animation sequence comprises providing a predetermined delay at the end of each iteration of the animation sequence such the animation sequence does not loop to the next iteration until the predetermined delay has elapsed after the end of the animation sequence.

66. A computer for combining animation and live video, the computer comprising:
means for generating an animation sequence; and
means for placing the animation sequence on a background such that the animation sequence can be combined with live video with the live video being substituted for the background.

67. A computer according to claim 59 wherein the background is of a uniform color and wherein the animation sequence comprises an animated character on the background such that no portion of the animated character comprises the uniform color.

68. A computer according to claim 59 wherein the background is of a uniform luminosity and/or intensity and wherein the animation sequence comprises an animated character on the background such that no portion of the animated character comprises the uniform luminosity and/or intensity.

69. A computer according to claim 68 wherein looping through iterations of the animation sequence comprises providing a predetermined delay at the end of each iteration of the animation sequence such the animation sequence does not loop to the next iteration until the predetermined delay has elapsed after the end of the animation sequence.

70. A computer according to claim 66 wherein generating the animation sequence comprises looping through iterations of the animation sequence.

71. A computer for combining animation and live video, the computer comprising:
an animation sequence generator that generates an animation sequence; and
a background generator that places the animation sequence on a background such that the animation sequence can be combined with live video with the live video being substituted for the background.

72. A computer according to claim 71 wherein the background is of a uniform color and wherein the animation sequence comprises an animated character on the background such that no portion of the animated character comprises the uniform color.

73. A computer according to claim 71 wherein the background is of a uniform luminosity and/or intensity and wherein the animation sequence comprises an animated character on the background such that no portion of the animated character comprises the uniform luminosity and/or intensity.

74. A computer according to claim 71 wherein the animation sequence generator loops through iterations of the animation sequence.

75. A computer according to claim 74 wherein looping through iterations of the animation sequence comprises providing a predetermined delay at the end of each iteration of the animation sequence such the animation sequence does not loop to the next iteration until the predetermined delay has elapsed after the end of the animation sequence.
